(19) United States
(12) Patent Application Publication
(10) Pub. No.: US 2007/0011721 A1
(43) Pub. Date: Jan. 11, 2007

(54) Data transmitting apparatus and data receiving apparatus

(76) Inventors: Koji Kanazawa, Ome-shi (JP); Masafumi Tamura, Chofu-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/444,581

(22) Filed: May 31, 2006

(30) Foreign Application Priority Data
May 31, 2005 (JP) 2005-160610

(51) Int. Cl. H04L 9/32

(52) U.S. Cl. 726/2

(57) ABSTRACT

According to one embodiment, a data transmitting apparatus includes an authentication unit configured to execute authentication processing between communication partners in order to confirm with each other, an encryption unit configured to encrypt data by using a session key generated from the authentication processing by the authentication unit, and a data transmitting unit configured to cause the encryption unit to encrypt a whole of data, in which verification data is added to plain data to be transmitted, as transmission data, and to transmit encrypted data obtained thereby to a communication partner who has been performed the authentication processing by the authentication unit.

### CROSS-REFERENCE TO RELATED APPLICATIONS

This application is based upon and claims the benefit of priority from Japanese Patent Application No. 2005-160610, filed May 31, 2005, the entire contents of which are incorporated herein by reference.

### BACKGROUND

1. Field

One embodiment of the invention relates to a data transmitting apparatus and a data receiving apparatus capable of checking validity of communication data which is encrypted and decrypted with the use of a session key, only by simple procedures on a reception side.

2. Description of the Related Art

In recent years, chances to transmit and receive a variety of data via a network to which a third party can access have been significantly increased in association with widespread use of the Internet. Accompanied by this, a large variety of methods to safely and surely transmit and receive data between a sender and a recipient have been proposed (refer to, for example, Japanese Patent Application Publication (KOKAI) No. 2003-122442, Japanese Patent Application Publication (KOKAI) No. 2002-290397 and Japanese Patent Application Publication (KOKAI) No. 2001-223735).

For instance, with authentication processing performed between the sender and the recipient and also with the communication data encrypted and decrypted by using the session key, each method can achieve prevention of a leakage and check of an alteration, etc., of the communication data. This type of method is usable even in such a case in which important data is transmitted and received via a universal interface such as a system bus laid on a personal computer.

By the way, in all methods which have been proposed conventionally are measurements for the prevention of leakages and the check of alterations of the communication data on communication passages. And the methods do not consider whether or not contents of plain data after decryption have any error therein, that is, do not consider the verification of the validity of the plain data.

Even if reception of encrypted data and its decryption have been performed properly on the reception side, the loss of the validity of the plain data obtained by the decryption is a possible case. Then, time loss as a data processing system becomes larger as the loss has been found in a later process of data processing executed on the reception side.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view in a state in which a display unit of a notebook-sized personal computer is opened regarding an embodiment of the invention;

FIG. 2 is an exemplary view showing a system configuration of the computer in the embodiment;

FIG. 3 is an exemplary block diagram for explaining an operational principal of an encrypted data communication executed between an encrypting device and a TV application program via a peripheral component interconnect (PCI) bus to be a universal interface in the computer in the embodiment;

FIG. 4 is an exemplary flowchart showing operation procedures on a transmitter side of the computer in the embodiment; and

FIG. 5 is an exemplary flowchart showing operation procedures on a receiver side of the computer in the embodiment.

### DETAILED DESCRIPTION

Various embodiments according to the invention will be described hereinafter with reference to the accompanying drawings. In general, according to one embodiment of the invention, a data transmitting apparatus comprises an authentication unit configured to execute authentication processing between communication partners in order to confirm with each other, an encryption unit configured to encrypt data by using a session key generated from the authentication processing by the authentication unit, and a data transmitting unit configured to cause the encryption unit to encrypt a whole of data, in which verification data is added to plain data to be transmitted, as transmission data, and to transmit encrypted data obtained thereby to a communication partner who has been performed the authentication processing by the authentication unit.

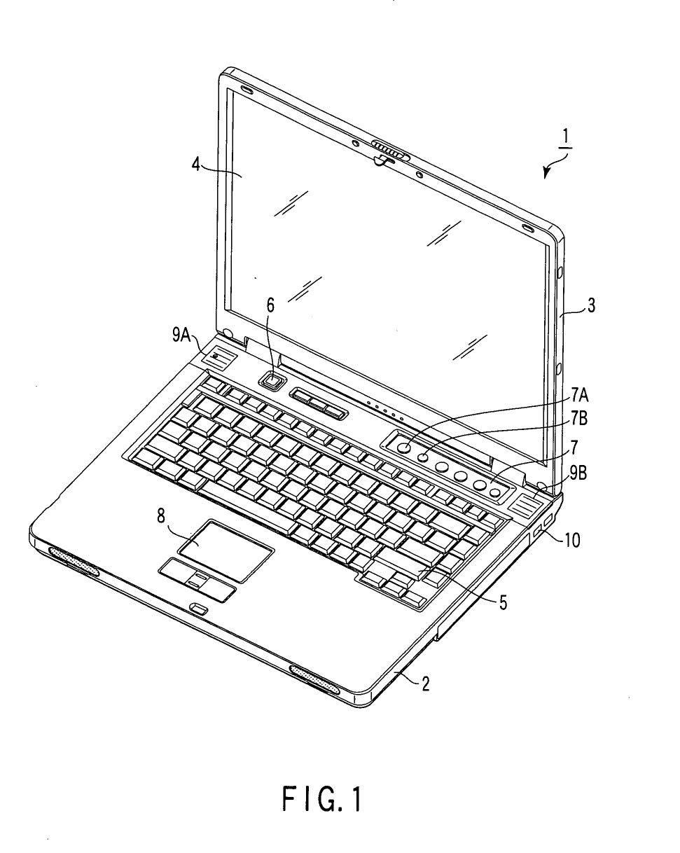

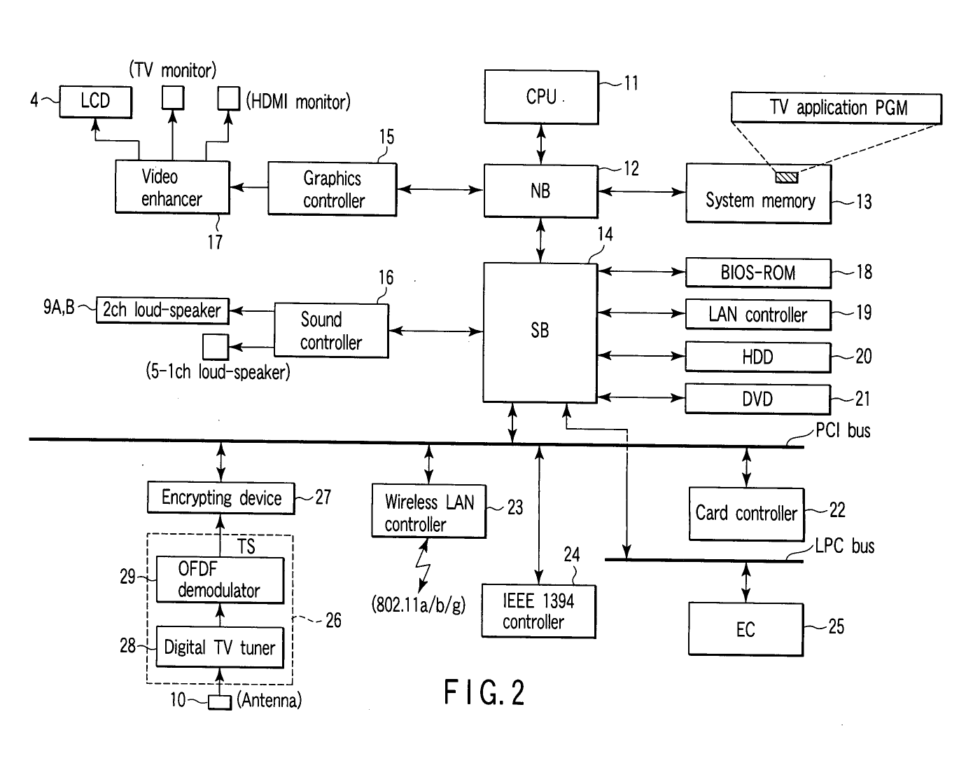

Referring to FIG. 1 and FIG. 2 firstly, a configuration of an information processing apparatus regarding an embodiment of the invention will be explained. The information processing apparatus is realized as, for example, a notebook-sized personal computer 1.

FIG. 1 is an exemplary perspective view in a state in which a display unit of the computer 1 is opened. The computer 1 consists of a computer main body 2 and a display unit 3. A display device composed of a thin-film transistor liquid crystal display (TFT-LCD) 4 is incorporated in the display unit 3 and the display screen of the LCD 4 is disposed at the approximate center of the display unit 3.

The display unit 3 is attached rotatably between an opening position and a closing position to the main body 2. The main body 2 has a housing with a thin box shape and arranges a keyboard 5, a power button to power on/power off the computer 1, an input operation panel 7, a touch pad 8 and loudspeakers 9A and 9B on its top surface.

The operation panel 7 is an input device to input an event corresponding to a depressed button and has a plurality of buttons to start a plurality of functions, respectively. The group of the buttons also includes a TV starting button 7A and a DVD/CD starting button 7B. The TV starting button 7A is a button in order to activate a TV function to reproduce and record TV broadcast program data and when a user depresses it, it starts a TV application program to execute the TV function.

A dedicated sub operating system to process audio video (AV) data other than a universal main operating system is installed in the computer 1. The TV application program is a program operating on the sub operating system.

When the user depresses the power button 6, the main operating system is started. In contrast, when the user depresses the TV starting button 7A, not the main operating system but the sub operating system is started to automatically execute the TV application program. The sub operating system has only a minimum function in order to execute an AV function. Therefore, a time required to boot up the sub operating system is far short in comparison with a time required to boot up the main operating system. Accordingly, the user can immediately perform TV viewing/recording only by pressing the TV starting button 7A.

The computer 1 can receive and reproduce terrestrial digital TV broadcasts. An antenna terminal 10 for the TV broadcast is provided on the right side surface of the main body 2.

The DVD/CD starting button 7B is a button to reproduce video contents recorded on a DVD and a CD. When the starting button 7B is depressed by the user, a video reproduction application program to reproduce the video contents is started. The video reproduction application program is also an application program operating on the sub operating system. When the DVD/CD starting button 7B is depressed by the user, not the main operating system but the sub operating system is started to automatically execute the video reproduction application program.

Next, the system configuration of the computer 1 will be described by referring to FIG. 2.

The computer 1, as shown in FIG. 2, comprises a CPU 11, a north bridge (NB) 12, a system memory 13, a south bridge (SB) 14, a graphics controller 15, a sound controller 16, a video enhancer 17, a basic input output system (BIOS)-ROM 18, a LAN controller 19, a hard disk drive (HDD) 20, a DVD drive (DVDD) 21, a card controller 22, a wireless LAN controller 23, an IEEE 1394 controller 24, an embedded controller (EC) 25, a digital TV broadcast reception processing unit 26 and an encrypting device 27.

The CPU 11 is a processor to control operations of the computer 1. And the CPU 11 executes the main operating system/sub operating system and a variety of application programs such as the TV application program loaded from the HDD 20 to the system memory 13. The CPU 11 also executes a system BIOS stored in the BIOS-ROM 18. The system BIOS is a program to control hardware.

The NB 12 is a bridge device to connect between the local bus of the CPU 11 and the SB 14. The NB 12 also has a built-in memory controller to control access to the system memory 13. The NB 12 also has a function to perform a communication with the graphics controller 15 via an accelerated graphics port (AGP) bus and a serial bus of a PCI express specification, etc.

The graphics controller 15 is a display controller to control the LCD 4 to be used as the display monitor of the computer 1. Video data generated from the graphics controller 15 is sent to a video enhancer 17 to be processed video processing (video quality adjustment processing) to enhance the video quality of the video data. The video data the video quality of which has been enhanced by the enhancer 17 is sent to the LCD 4. The video data the video quality of which has been enhanced by the enhancer 17 can also be sent to an external TV monitor and an HDMI monitor through connectors disposed at the main body 2.

The SB 14 controls each device on a low pin count (LPC) bus and a PCI bus. The SB 14 has a built-in integrated drive electronics (IDE) controller to control the HDD 20 and the DVDD 21. The SB 14 further has a function to execute a communication with the sound controller 16.

The sound controller 16 is a sound source device and outputs audio data to be reproduced to the loudspeakers 9A and 9B and an external 5-1 channel loudspeaker system connected through connectors.

The card controller 22 controls a card such as a PC card and a secure digital (SD) card. The wireless LAN controller 23 is a radio communication device executing a radio communication of, for example, IEEE 802.11 standards. The IEEE 1394 controller 24 performs a communication with external equipment via a serial bus of IEEE 1394 standards. The EC 25 is a one-chip microcomputer with an embedded controller to manage power and a keyboard controller to control the keyboard 5 and the touch pad 8 integrated therein. The EC 25 has a function to power on/power off the computer 1 in response to operations of the power button 6 by the user. The EC 25 further enables powering on the computer 1 in response to operations of the TV starting button 7A and the DVD/CD starting button 7B by the user.

The digital TV broadcast reception processing unit 26 is a device to receive a digital broadcast program such as a terrestrial digital TV broadcast and connected to the antenna terminal 10. The processing unit 26 has, as shown in FIG. 2, a digital TV tuner 28 and an orthogonal frequency division multiplexing (OFDM) demodulator 29. The tuner 28 and the modulator 29 function as a tuner module to receive broadcast program data of the terrestrial digital TV broadcast. The TV broadcast utilizes an MPEG 2 as a compression coding system to each broadcast program data (video and audio). For a video format, high definition (HD) with a high resolution is used.

The processing unit 26 consisting of the TV tuner 28 and the OFDM modulator 29 receives a broadcast signal of a specified channel among TV broadcast signals input from the antenna terminal 10 to extract a transport stream (hereinafter, referred to as TS) from the received TV broadcast signal. The TS is one with compressed and encoded broadcast contents multiplexed therein. In the terrestrial digital TV broadcast, a plurality of programs are multiplexed at every channel (physical channel).

The encrypting device 27 decrypts the TS input from the processing unit 26 then re-encrypts it by use of an encryption key shared with the TV application program to transfer it to the system memory 13 through the PCI bus. The re-encryption is performed in order to prevent the taken out broadcast program data from being reproduced even when the program data has been taken out improperly through the PCI bus.

In other words, the computer 1 transmits and receives the important data via the universal interface such as the PCI bus. The computer 1 makes it possible not only to prevent a leakage of data and check an alteration on the PCI bus but also to verify whether or not a content of plain data decrypted on a reception side is correct, only by simple procedures on a reception side. This point will be described in detail below.

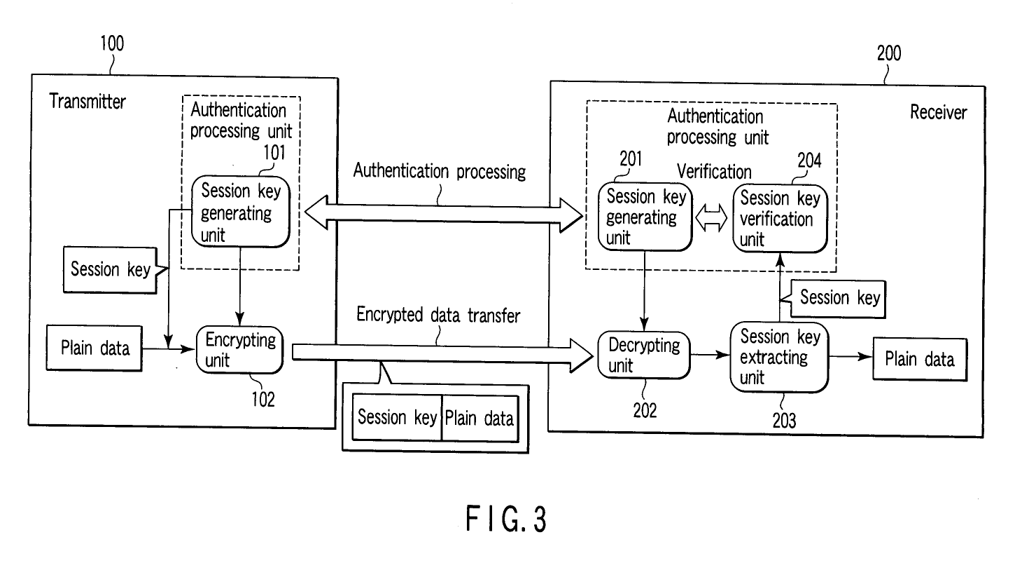

FIG. 3 is an exemplary functional block diagram for explaining an operation principal of an encrypted data communication implemented between the encrypting device 27 and the TV application program via the PCI bus that is the universal interface. A transmitter 100 and a receiver 200 correspond to the encrypting device 27 and the TV application program, respectively.

The transmitter 100 and the receiver 200 have authentication processing units performing authentication processing in order to establish encrypted data communication paths, respectively. Timing to perform the authentication processing is not limited specifically and normal completions of the authentication processing make each authentication processing unit generate each session key. For example, in the case in which the encryption system is the advanced encryption standard (AES) of 128-bit, the session keys each generated from the authentication processing units are ones of 128-bit. In this case, data blocks to be encrypted are cipher block chaining (CBC)-encrypted in 128-bits.

The plain data in FIG. 3 is data to actually become a transfer object, and wherein it is presumed to be 128-bit data. In this embodiment, the transmission of the plain data from the transmitter 100 to the receiver 200 utilizes the session key, generated between the persons concerned by the authentication processing, also as verification data. In this example, the session key data is presumed to be 128-bit data.

The transmitter 100 adds a session key generated from a session key generating unit 101 to the head of the plain data, as the verification data. A whole of data of 256-bit consisting of the session key and the plain data is transferred to an encrypting unit 102, and the transferring shows that it is CBC-encrypted by a 128-bit key of the session key, as a data block of 256-bit. Having added the session key to the head of the plain data in this example, it is not limited that case and it may be added to, for example, a tail thereof.

The encrypted data is decrypted by a decrypting unit 202 with a session key generated from a session key generating unit 201. A session key extracting unit 203 extracts a head of 128-bit as the verification data, i.e., a session key from the encrypted data. A session key verifying unit 204 compares the session key extracted as the verification data to the session key generated from the session key generating unit 201 to determine that the plain data after encryption is normal one if the authentication result does not present any problem.

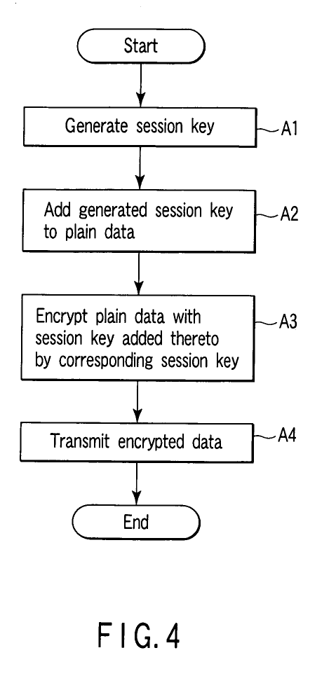

FIG. 4 is an exemplary flowchart showing operation procedures of the transmitter 100.

When generating the session key (block A1), the transmitter 100 adds the generated session key to the plain data (block A2). The transmitter 100 encrypts the plain data with the session key added thereto by using the session key (block A3) to transmit the encrypted data to the receiver 200 (block A4).

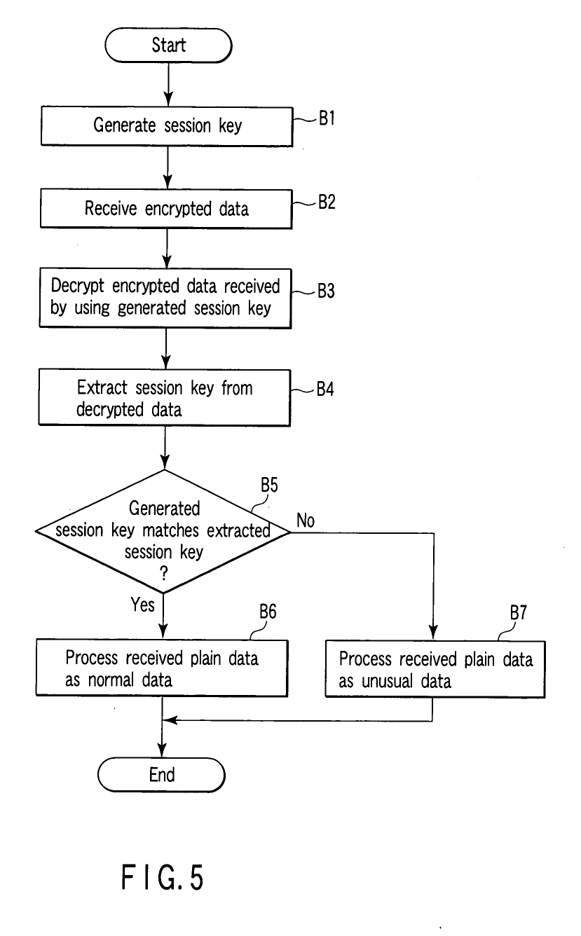

FIG. 5 is an exemplary flowchart showing operation procedures of the receiver 200.

The receiver 200 generates the session key (block B1), and when receiving the encrypted data from the transmitter 100 (block B2), decrypts the received encrypted data by use of the generated session key (block B3).

Successively, the receiver 200 extracts the session key as the verification data from the encrypted data (block B4). The receiver 200 checks whether the extracted session key matches or not the generated session key (block B5), if they match with each other (YES, in block B5), processes the received plain data as the normal data (block B6). Conversely, if they do not match each other (NO, in block B5), the receiver 200 processes the received plain data as unusual data (block B7).

As mentioned above, the computer 1 in the embodiment enables checking the validity of the communication data which has been encrypted and decrypted using the session key, only by simple procedures on the reception side.

Having utilizing the session key as the verification data in the aforementioned embodiment, a hash value of the plain data, intermediate data or the like generated in a generation process of the session key, other than the session key, may be used as the verification data. Furthermore, it is possible for a value prescribed between the sender and the recipient to be used as the verification data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data transmitting apparatus, comprising:
an authentication unit configured to execute authentication processing between communication partners in order to confirm with each other;
an encryption unit configured to encrypt data by using a session key generated from the authentication processing by the authentication unit; and
a data transmitting unit configured to cause the encryption unit to encrypt a whole of data, in which verification data is added to plain data to be transmitted, as transmission data, and to transmit encrypted data obtained thereby to a communication partner who has been performed the authentication processing by the authentication unit.

2. The data transmitting apparatus according to claim 1, wherein the data transmitting unit adds the session key, as the verification data, to the plain data to be transmitted.

3. The data transmitting apparatus according to claim 1, further comprising a hash value calculation unit configured to calculate a hash value, wherein
the data transmitting unit causes the hash value calculation unit to calculate a hash value of the plain data to be transmitted and adds the hash value obtained thereby, as the verification data, to the plain data to be transmitted.

4. The data transmitting apparatus according to claim 1, wherein the data transmitting unit adds intermediate data, obtained in a process in which the session key is generated in the authentication processing by the authentication unit, as the verification data, to the plain data to be transmitted.

5. The data transmitting apparatus according to claim 1, wherein the data transmitting unit adds the verification data to a head of the plain data to be transmitted.

6. The data transmitting apparatus according to claim 1, wherein the data transmitting unit adds the verification data to a tail of the plain data to be transmitted.

7. A data receiving apparatus, comprising:
an authentication unit configured to execute authentication processing between communication partners in order to confirm with each other;
a data receiving unit configured to receive encrypted data from a communication partner who has been performed the authentication processing by the authentication unit;
a decryption unit configured to decrypt the encrypted data by using a session key generated from the authentication processing by the authentication unit; and
a determining unit configured to extract verification data added to plain data to be received from a whole of reception data decrypted by the decryption unit and to determine validity of the plain data to be received by comparing the extracted verification data with prescribed data.

8. The data receiving apparatus according to claim 7, wherein the determining unit compares the session key with the verification data extracted as the prescribed data.

9. The data transmitting apparatus according to claim 1, further comprising a hash value calculation unit configured to calculate a hash value, wherein
the determining unit causes the hash value calculation unit to calculate a hash value of the plain data to be received included in reception data decrypted by the decryption unit and compares the hash value obtained thereby with the verification data extracted as the prescribed data.

10. The data receiving apparatus according to claim 7, wherein the determining unit compares intermediate data, obtained in a process in which the session key is generated from the authentication processing by the authentication unit, as the verification data, with the verification data.

11. The data receiving apparatus according to claim 7, wherein the determining unit extracts the verification data from a head of a whole of reception data decrypted by the decryption unit.

12. The data receiving apparatus according to claim 7, wherein the determining unit extracts the verification data from a tail of a whole of reception data decrypted by the decryption unit.
